(19) United States
(12) Patent Application Publication
(10) Pub. No.: US 2009/0305633 A1
(43) Pub. Date: Dec. 10, 2009

(54) Identification of Mobile Electronic Terminal Through Wireless Interface Capabilities

(76) Inventor: Ville Warsta, Helsinki (FI)

Correspondence Address: Hollingsworth & Funk, 8500 Normandale Lake Blvd., Suite 320, Minneapolis, MN, 55437, US

(21) Appl. No.: 12/224,920

(22) PCT Filed: Mar. 9, 2006
(86) PCT No.: PCT/IB2006/000512

§ 371 Date: Dec. 22, 2008

(51) Int. Cl. H04B 7/00

(52) U.S. Cl. 455/41.2

(57) ABSTRACT

The present invention provides a method for determining an identification of a mobile electronic terminal comprising at least one wireless interface, the method comprising maintaining a database storing a plurality of data sets, wherein each data set is indicative of capabilities of a wireless interface and associated with at least one identification of a mobile electronic terminal, receiving wireless interface capability data from said wireless interface, comparing said received wireless interface capability data with said stored data sets, and determining an identification of said mobile electronic terminal on the basis of said comparison. The invention further provides a device for determining an identification of a mobile electronic terminal which comprises at least one wireless interface, the device comprising a database access component adapted for accessing a database comprising a plurality of data sets, wherein each data set is indicative of capabilities of a wireless interface and is associated with at least one mobile electronic terminal, a wireless interface adapted for requesting wireless interface capabilities from said wireless interface of said mobile electronic terminal, and for receiving wireless interface capability data from said wireless interface, and a controller adapted for comparing said received wireless interface capability data with said plurality of data sets, and for determining an identification of said mobile electronic terminal on the basis of said comparison.

The present invention relates to a method and a system for identifying a mobile electronic terminal through short-range communication links. It particularly concerns identifying a mobile electronic terminal at a Bluetooth access point, using Bluetooth service discovery mechanisms, for providing targeted services specifically tailored to the mobile electronic terminal in question.

### BACKGROUND OF THE INVENTION

Local connectivity interfaces are recently becoming a standard feature even in low-cost mobile phones and similar devices. This allows these interfaces such as Bluetooth to be used also for other use cases in addition to the traditional cases as the use of a wireless headset/hands free device. It is currently assumed that there are business cases for utilizing Bluetooth in scenarios previously not regarded as important with respect to business. Some of these scenarios require proprietary software in the handset such that a particular use case can be provided to the end-user. It might be an example to offer a local content download over Bluetooth, wherein the user needs client software for browsing the content that is offered. However, in order to provide suitable client software for the mobile terminal in question terminal specific details, such as, for example the terminal model/type/operating system version etc., need to be known.

In addition, if other possible use cases are considered, wherein a wireless short-range access point wants to provide targeted services to mobile terminals, it would be beneficial for the access point to know the device model/type to in order to provide suitable and specifically tailored services.

One could assume that technologies such as Java would have removed the need for creating different software versions of an application for a mobile device. Unfortunately that is actually not the case—e.g. even with different phone models of the same manufacturer, different client software versions are required to take advantages of most of the terminals capabilities.

Since such an application is used over local connection technologies such as Bluetooth, it would be preferable to deliver the required software client over Bluetooth as well. Unfortunately there exists no standard mechanism in Bluetooth to query for the terminal model or platform operating system of the target device.

Prior art solutions to this problem were performed by instructing the user to send an electronic business card over Bluetooth to a service point (i.e. servicing access point) providing the local content download functionality. Based on the information of the business card, the service point can recognize the terminal type/version etc., and is enabled to send back the specific client software for installation by the user.

With this prior art scheme the assumption is that the user will create an electronic business card based on the terminal type the user is utilizing. That is, that a different card will respectively be created for different terminals. The problem here is that for most users the only relevant thing they know about their terminal is that it is simply a Nokia phone, for example. In other words, if the user of the terminal is asked to provide information on the terminal's model/type, there always exists the possibility that the model/type information provided to the service point will be erroneous. This in turn would lead to a number of problems, when e.g. inappropriate software is sent to the terminal. Furthermore providing guidance for the user to select a correct terminal type is problematic.

Therefore it would be advantageous if the determination/recognition of the user's terminal type/version etc. could be performed automatically without requiring any kind of user interaction. This can help to make the service offering more error-proof and user-friendly.

### SUMMARY OF THE INVENTION

According to an aspect of the present invention a method for determining an identification of a mobile electronic terminal comprising at least one wireless interface is provided. The method comprises the steps of
maintaining a database storing a plurality of data sets, wherein each data set is indicative of capabilities of a wireless interface and associated with at least one identification of a mobile electronic terminal;
receiving wireless interface capability data from said wireless interface;
comparing said received wireless interface capability data with data sets, wherein each data set is indicative of capabilities of a wireless interface and is associated with at least one identification of a mobile electronic terminal; and
determining an identification of said mobile electronic terminal on the basis of said comparison.

This method enables a requesting device, e.g. a servicing access point, to reliably determine the type/model etc. of a mobile terminal. The determination is performed in an automatic manner, without requiring user interaction, and without relying on specific versions/features of the actual implementation of the wireless interface in the mobile terminal. Determining the type etc. of a mobile device enables advanced services, as will be detailed in the further specification.

According to an exemplary embodiment the receiving step is preceded by
requesting wireless interface capabilities from said wireless interface of said mobile electronic terminal.

According to an exemplary embodiment the comparing is performed according to one or more parameters from the group comprising:
the number of capabilities of said wireless interface;
the type of a wireless interface capability;
the order of wireless interface capabilities; and
the position of a wireless interface capability within said wireless interface capability data.

According to an exemplary embodiment the comparing step comprises:
finding at least one correspondence between said received wireless interface capability data and said data sets, wherein said correspondence is an identical match or a similarity exceeding a pre-determined threshold;
   wherein said step of determining an identification of said mobile electronic terminal is based on
the single correspondence, in case a single correspondence is found;
   or
a selected correspondence, in case multiple correspondences are found.

The correspondence is selected, in case this is necessary, according to at least one of the group comprising:
number sold/in use of mobile electronic terminal associated with said correspondence;
number/kind of features of mobile electronic terminal associated with said correspondence; and
manufacturer of mobile electronic terminal associated with said correspondence.

The decision in case there are multiple correspondences is apparently important, and these are useful parameters to take this decision. The requesting device can e.g. choose to assume that the mobile terminal to be identified will most probably be one which has been sold/is in use in a big number, while another terminal having a correspondence may only be used very rarely. Or the servicing access point may be configured to offer specific services only to a limited number of devices, e.g. from a specific manufacturer or the like.

According to an exemplary embodiment the method further comprises:
selecting a client software in accordance with said identification of said mobile electronic terminal; and
transmitting said selected client software to said mobile electronic terminal using said wireless interface.
   Using the invention specifically tailored client software can be offered to a mobile terminal device, over the wireless interface.

According to an exemplary embodiment the method further comprises:
selecting content data in accordance with said identification of said mobile electronic terminal; and
transmitting said selected content data to said mobile electronic terminal using said wireless interface.
   Also suitable data content can be selected using the determination of the invention, e.g. only multimedia content that can be played back by the mobile terminal in question.

According to an exemplary embodiment the method further comprises:
selecting a service in accordance with said identification of said mobile electronic terminal; and
enabling said selected service for said mobile electronic terminal.
   The above mentioned advantages can also be used for enabling only suitable services for a mobile terminal identified according to the invention.

According to an exemplary embodiment the received wireless interface capability data include a unique wireless interface identifier, said method further comprising:
maintaining an association between said unique wireless interface identifier and said identification of said mobile electronic terminal.
   The identification of the mobile terminal achieved by the present invention can advantageously be used further together with a unique wireless identifier, in order to create an (e.g. database) association for being able to identify the same terminal later on, with even simpler means.

According to another aspect of the invention a computer program product is provided, comprising program code means, stored on a computer-readable medium, for carrying out the method described above, when said computer program product is run on a computer or network device.

According to yet another aspect of the invention a device is provided, for determining an identification of a mobile electronic terminal which comprises at least one wireless interface, the device comprising:
a database access component adapted for accessing a database comprising a plurality of data sets, wherein each data set is indicative of capabilities of a wireless interface and is associated with at least one mobile electronic terminal;
a wireless interface adapted for requesting wireless interface capabilities from said wireless interface of said mobile electronic terminal, and for receiving wireless interface capability data from said wireless interface; and
a controller adapted for comparing said received wireless interface capability data with said plurality of data sets, and for determining an identification of said mobile electronic terminal, on the basis of said comparison.

According to an exemplary embodiment the controller is adapted for performing said comparison according to one or more parameters from the group comprising:
number of capabilities of said wireless interface;
type(s) of wireless interface capability/capabilities; and
position(s) of wireless interface capability/capabilities within said wireless interface capability data.

According to an exemplary embodiment the controller is adapted for finding at least one correspondence between said received wireless interface capability data and said data sets, wherein said correspondence is an identical match or a similarity exceeding a pre-determined threshold, and for basing said determining of an identification of said mobile electronic terminal on
the single correspondence, in case a single correspondence is found;
   or
a selected correspondence, in case multiple correspondences are found.

According to an exemplary embodiment the controller is adapted for selecting said correspondence according to at least one of the group comprising:
number sold/in use of the mobile electronic terminal associated with said correspondence;
number/kind of features of the mobile electronic terminal associated with said correspondence; and
manufacturer of the mobile electronic terminal associated with said correspondence.

According to an exemplary embodiment the wireless interface is a Bluetooth interface.

According to an exemplary embodiment the device further comprises a memory component adapted to be accessed by said database access component, wherein said memory component is adapted for storing said database comprising said plurality of data sets.

According to an exemplary embodiment the memory component is adapted for storing associations between mobile electronic terminal identifiers and client software suitable for respective mobile electronic devices, and wherein said controller is further adapted for selecting a client software from said stored associations in accordance with said identification of said mobile electronic terminal, and for transmitting said selected client software to said mobile electronic terminal using said wireless interface.

According to an exemplary embodiment the memory component is adapted for storing associations between mobile electronic terminal identifiers and data content suitable for respective mobile electronic devices, wherein said controller is further adapted for selecting content data in accordance with said identification of said mobile electronic terminal, and for transmitting said selected content data to said mobile electronic terminal using said wireless interface.

According to an exemplary embodiment the memory component is adapted for storing associations between mobile electronic terminal identifiers and data services suitable for respective mobile electronic devices, wherein said controller is further adapted for selecting a service in accordance with said identification of said mobile electronic terminal, and for enabling said selected service for said mobile electronic terminal.

According to an exemplary embodiment the received wireless interface capability data include a unique wireless interface identifier, and wherein said controller is further adapted for storing an association between said unique wireless interface identifier and said mobile electronic terminal in said memory component.

According to still another aspect of the invention a system is provided, comprising at least one device as described above, and further comprising:
a memory component storing said database comprising said plurality of data sets; and
an interface component adapted for providing said database access component access to said database.

According to an exemplary embodiment the memory component further stores associations between mobile electronic terminal identifiers and client software suitable for respective mobile electronic devices, and wherein said controller is further adapted for selecting a client software from said stored associations in accordance with said identification of said mobile electronic terminal, and for transmitting said selected client software to said mobile electronic terminal using said wireless interface.

According to an exemplary embodiment the memory component further stores associations between mobile electronic terminal identifiers and data content suitable for respective mobile electronic devices, wherein said controller is further adapted for selecting content data in accordance with said identification of said mobile electronic terminal, and for transmitting said selected content data to said mobile electronic terminal using said wireless interface.

According to an exemplary embodiment the memory component further stores associations between mobile electronic terminal identifiers and data services suitable for respective mobile electronic devices, and said controller is further adapted for selecting a service in accordance with said identification of said mobile electronic terminal, and for enabling said selected service for said mobile electronic terminal.

According to an exemplary embodiment the received wireless interface capability data include a unique wireless interface identifier, and said controller is further adapted for storing an association between said unique wireless interface identifier and said mobile electronic terminal in said memory component.

### BRIEF DESCRIPTION OF THE DRAWINGS

The invention can better be understood by referring to the enclosed drawings, which are provided solely for illustration purposes, and wherein:

FIG. 1 is a flow diagram of an embodiment of the inventive method;

FIGS. 2a and 2b are examples of wireless interface capability data, as used by the invention; and

FIG. 3 is a schematic diagram showing components of an embodiment of a device and/or system according to the present invention.

### DETAILED DESCRIPTION OF THE INVENTION

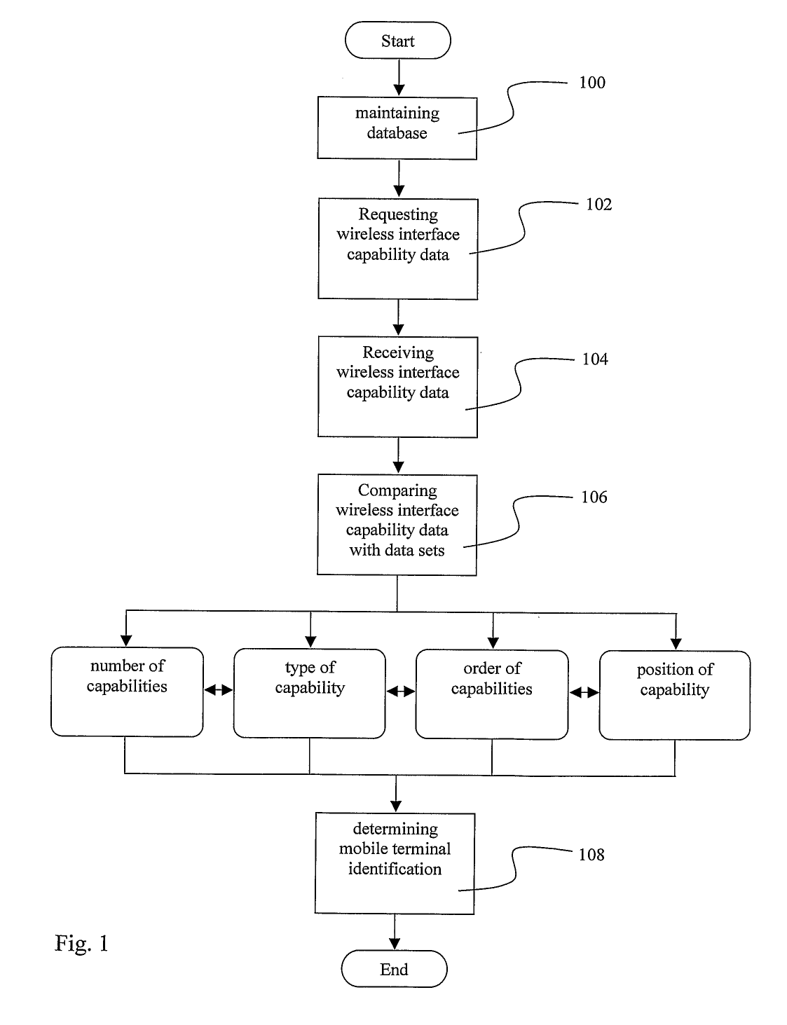

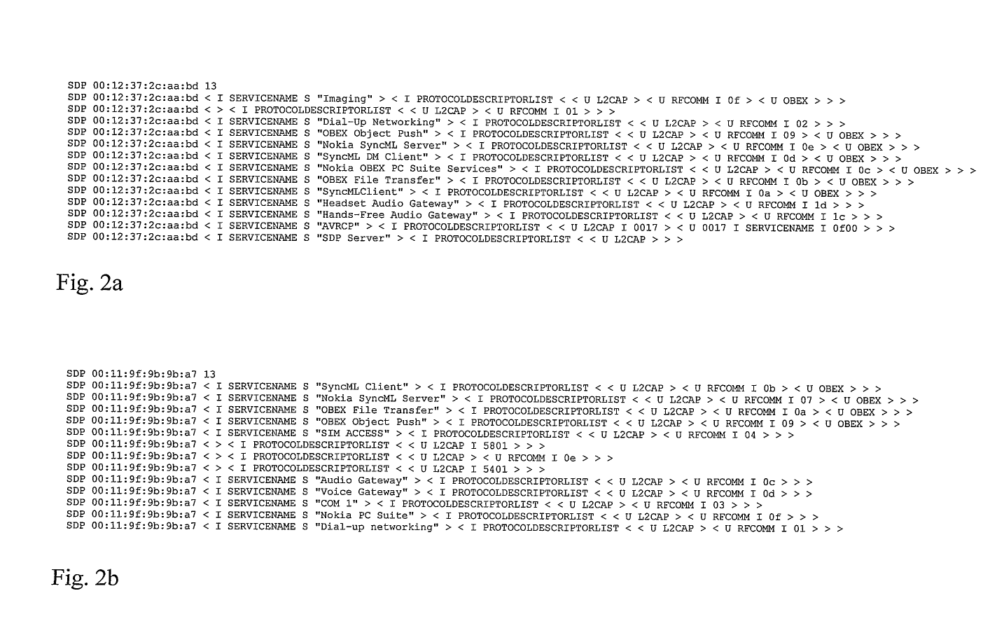

FIG. 1 illustrates the steps of an embodiment of the present invention. In step 100 a database storing a plurality of data sets is maintained, wherein each data set is indicative of capabilities of a wireless interface and associated with at least one identification of a mobile electronic terminal. In step 102 the capabilities of the wireless interface of a mobile electronic terminal are requested. In case the wireless interface is a Bluetooth interface, this may be performed according to Bluetooth Service Discovery Protocol (SDP). Additional methods related to BT could also be used; e.g. using L2CAP (Logical Link Control and Adaptation Protocol) protocol PDUs (Packet Data Units) for recognizing the type of Bluetooth stack. This is a scheme comparable to TCP/IP fingerprinting where the host operating system can be determined only by sending different TCP packets. In response to the request wireless interface capability data are received in step 104. Examples of such data are shown in more detail in FIGS. 2a and 2b.

In step 106 the wireless interface capability data are then compared with data sets being indicative of capabilities of wireless interfaces. These data sets will usually be stored within a database, together with an associated identifier of a mobile electronic device (e.g. Nokia 6270). The comparing step 106 may be based on one or more of the criteria depicted below in step 106. That is, the received wireless interface capability data can be compared with the data sets with respect to the number of reported capabilities, the type of a particular capability (does the mobile terminal support “Nokia SyncML Server” or like?), the order in which the capabilities are reported within the wireless interface capability data, and also the position of a certain capability (is the capability “Nokia SyncML Server” arranged at second position?). Naturally these criteria can also be utilized in combinations:

Does the terminal support “Nokia SyncML Server” and is it reported on second position? If yes, determine that the terminal is for example a Nokia 6270 mobile phone. This determination is performed in step 108. The determined type/model of the mobile terminal can now be used to offer specific client software/data content/data services to the mobile terminal. That is, over the wireless interface e.g. browser/media player software can be offered to the terminal, then furthermore corresponding data content (e.g. video file or other multimedia file), and probably even a data service (life streaming of a football match or like). All of these offers can be specifically tailored to the actual mobile terminal model/OS version etc. Additionally the inventive method can be applied to any mobile terminal with a wireless interface capable of reporting its capabilities in the above described manner, irrespective of the particular supported wireless interface version.

That is, the present invention does not rely on any specific device identification schemes or protocols which may be a non-mandatory part of the particular wireless interface protocol. Instead the invention provides means for performing the device identification independent from such optional (and possibly even proprietary) protocols, such that interoperability with a large number of mobile terminals can be ensured without depending on the actual wireless interface implementation (e.g. Bluetooth version).

FIGS. 2a and 2b depict examples of wireless interface capability data as they are used with the present invention. The data shown in FIG. 2a correspond to a Bluetooth SDP request from a mobile terminal, in this case a Nokia E70 Series 60 3.0 with a Symbian operating system. This figure should be self-explaining, and shows typical Bluetooth capabilities as “Headset Audio Gateway”, “OBEX Object Push” and others. FIG. 2b is a data set as it may be received similarly with a Bluetooth SDP request, but in this case from a different mobile terminal, a Nokia 6270, which has an ISA operating system.

As can be seen here these received wireless interface capability data sets may be distinguished. Although these two examples comprise the same number of capabilities, in this case 14, in other examples already the number of reported capabilities can be used to distinguish two received data sets. Further criterions that can be used in accordance with the present invention comprise the position of a particular capability. In this example here e.g. the “Nokia SyncML Server” is arranged on the sixth (FIG. 2a) or second (FIG. 2b) position. Another possibility for distinguishing the data sets is to determine if a particular capability is reported. E.g. “Voice Gateway” is only contained in the data set depicted in FIG. 2b, while on the other hand “SDP Server” is only contained in the data set of FIG. 2a. Still another criterion is related to the order in which pluralities of capabilities are arranged. In this example e.g. the order of “Nokia SyncML Server” and “SyncML Client” is different in the two data sets. One could for example assume that “Nokia SyncML Server” being arranged successive to “SyncML Client” is indicating that the mobile terminal in question is a Nokia 6270, while the other way round (and additionally with entries in-between) indicates that the terminal is a Nokia E70.

These above mentioned examples are just to illustrate the present invention. Combinations can of course also be used, and the cited particular capabilities are also to be understood as being only exemplary. Other information may be used (additionally), like Class of Service of the mobile terminal, which can be found out by doing a Bluetooth inquiry.

The term “indicative of capabilities of a wireless interface” is to be understood, in the context of the present invention, as e.g. a data set comprising the information “14 capabilities reported”; “Nokia SyncML Server” arranged on sixth position; capability “SDP Server” present. This data set would then comprise an association with the corresponding terminal identification, in this example “Nokia E70”. By evaluating the capabilities of the wireless interface in the above described manner the present invention thus enables to determine the identification of a mobile terminal, in an interoperable manner independent from specific wireless interface implementation.

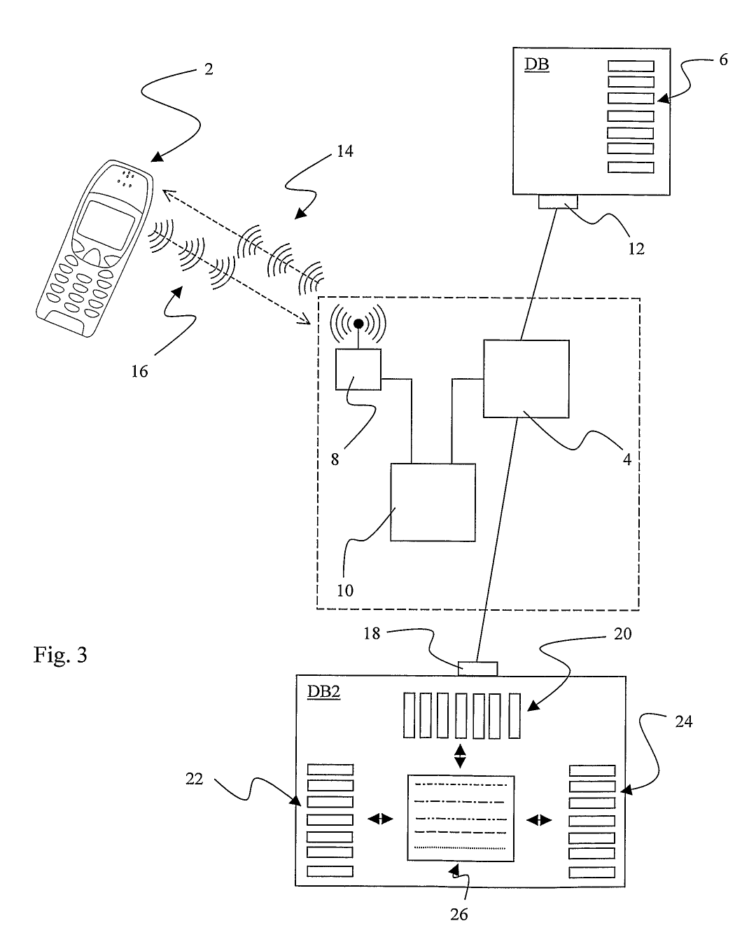

FIG. 3 illustrates an embodiment of a device/system according to the present invention, for determining an identification of a mobile electronic terminal 2. The device comprises a database access component 4, a controller 10, and a wireless interface 8. The database access component 4 is capable of accessing a database DB, wherein a plurality of data sets 6 is stored. The database DB also comprises an interface 12 allowing the database access component to access the data sets 6. This database DB can be external to what is indicated by the dashed box; in this case the figure is related to the system of the invention. However the database DB can also be integrated together with the components in the dashed box, in this case the figure is related to an embodiment of the device according to the invention.

The controller 10 operates the wireless interface 8 such that a request for wireless interface capabilities of the mobile terminal 2 is issued (indicated by 14). The mobile terminal 2 will then respond (indicated by 16) with wireless interface capability data which are received from the wireless interface 8. The controller 10 is adapted to compare this received data with the data sets 6 within the database DB. According to what has already been detailed in conjunction with FIGS. 1, 2a and 2b the controller 10 can determine the actual identification of the mobile terminal 2.

In advanced embodiments the device/system of the invention further comprises another database DB2, which can store associations between identifiers of mobile electronic terminals 26, client software (versions) 20, content data 22 and also data services 24. The controller 10 can access this database DB2 via the database access component 4 and a database interface 18 in order to provide specific client software and data content to the identified mobile terminal 2, or for enabling a suitable data service for the mobile terminal. Also this database DB2 can be external to what is shown in the dashed box, e.g. somewhere remote on the other side of a wired or wireless network. It should be noted that the two databases DB and DB2 can also be integrated into one database, in further embodiments of the inventive device/system. Also any database can be external to, or be integrated to what is in the dashed box, depending on the specific demand.

This invention provides a mechanism for a requesting device (e.g. servicing Access Point) for receiving necessary information from a target device by way of conducting device discovery and connection set-up procedures and gathering the needed information by way of requesting wireless interface capability information from the target device during the processes, in order to determine the type/model of the target device, e.g. using a dedicated type/model software agent and a pre-stored device type/model capabilities database. This can be performed automatically without the active help of a user of a mobile device.

In other words, the servicing access point is enabled to gather capability information regarding the target terminal device during the connection set-up procedures (particularly Service Discovery Protocol (SDP) records of Bluetooth) and provides this information to a dedicated type/model software agent, which performs mapping of the results within the dedicated device type/model capabilities database that comprises information regarding capabilities of various different device models of various device manufacturers. Based on identified matches of the mapping between the received information from the target device and the pre-stored device type/model database, the software agent is capable of providing a determination of the type and/or model of the target device.

Using this information the servicing access point can provide suitable services/client software/content to the target device as e.g. stored in another dedicated database containing associations between the device type/model and operating system/software version and/or additional features list. An example of such an association may be the determined operating system/software of a certain mobile phone model, and also the definition whether a particular phone model is equipped with e.g. an MP3 player or other similar features, such as, for example, display capabilities or the supported audio interface. Using standard Bluetooth SDP alone the mobile terminal cannot provide the servicing access point with such information.

Thus one use case is the above-mentioned delivery of client software required to access a certain local connectivity service. Other use cases could be the transmission of relevant content to users with Bluetooth, based on the terminal model used. Examples for this could be security fixes of the operating software of a mobile phone, firmware updates and the like. Another example can be to only send Nokia related ads to a Nokia phone.

In some embodiments of the present invention the dedicated software agent makes the mapping based on only pre-defined rules. In alternative embodiments the dedicated software agent is capable of learning during the process, so that the agent may either learn various combinations and use that information in connection with future device type/model definitions, or even store the Bluetooth_ADDR wireless identifier of the target device to a substantially permanent or temporary storage that can be used later on to define the target terminal type/model rapidly using only the device discovery (Inquiry) for defining the target terminal type/model. For example, one way of such a learning process could be performed such that when an unknown terminal uses an application that was sent to the terminal, the server side can note, based on information received from the client application, the terminal model and store it for future usage.

For local connectivity services the most difficult step in the process of actually utilizing the service is how to bootstrap the required client software to the end-user's phone. The invention can assist in this step enormously, as there are no specific instructions required for every possible phone model, and the user does not have to know the real phone model he is using.

1. Method for determining an identification of a mobile electronic terminal comprising at least one wireless interface, the method comprising:
maintaining a database storing a plurality of data sets, wherein each data set is indicative of capabilities of a wireless interface and associated with at least one identification of a mobile electronic terminal;
receiving wireless interface capability data from said wireless interface;
comparing said received wireless interface capability data with said stored data sets; and
determining an identification of said mobile electronic terminal on the basis of said comparison.

2. Method according to claim 1, further comprising requesting wireless interface capabilities from said wireless interface of said mobile electronic terminal.

3. Method according to claim 1, wherein said comparing is performed according to one or more parameters from the group comprising:
the number of capabilities of said wireless interface;
the type of a wireless interface capability;
the order of wireless interface capabilities; and
the position of a wireless interface capability within said wireless interface capability data.

4. Method according to claim 1, wherein said comparing comprises:
finding at least one correspondence between said received wireless interface capability data and said data sets, wherein said correspondence is an identical match or a similarity exceeding a pre-determined threshold;
wherein said step of determining an identification of said mobile electronic terminal is based on
the single correspondence, in case a single correspondence is found;
or
a selected correspondence, in case multiple correspondences are found.

5. Method according to claim 4, wherein said correspondence is selected according to at least one of the group comprising:
number sold/in use of mobile electronic terminal associated with said correspondence;
number/kind of features of mobile electronic terminal associated with said correspondence; and
manufacturer of mobile electronic terminal associated with said correspondence.

6. Method according to claim 1, further comprising:
selecting a client software in accordance with said identification of said mobile electronic terminal; and
transmitting said selected client software to said mobile electronic terminal using said wireless interface.

7. Method according to claim 1, further comprising:
selecting content data in accordance with said identification of said mobile electronic terminal; and
transmitting said selected content data to said mobile electronic terminal using said wireless interface.

8. Method according to claim 1, further comprising:
selecting a service in accordance with said identification of said mobile electronic terminal; and
enabling said selected service for said mobile electronic terminal.

9. Method according to claim 1, wherein said received wireless interface capability data include a unique wireless interface identifier, said method further comprising maintaining an association between said unique wireless interface identifier and said identification of said mobile electronic terminal.

10. Computer program product, comprising program code means, stored on a computer-readable medium, for carrying out the method of claim 1, when said computer program product is run on a computer or network device.

11. Device for determining an identification of a mobile electronic terminal which comprises at least one wireless interface, the device comprising:
a database access component adapted for accessing a database comprising a plurality of data sets, wherein each data set is indicative of capabilities of a wireless interface and is associated with at least one mobile electronic terminal;
a wireless interface adapted for requesting wireless interface capabilities from said wireless interface of said mobile electronic terminal, and for receiving wireless interface capability data from said wireless interface; and
a controller adapted for comparing said received wireless interface capability data with said plurality of data sets, and for determining an identification of said mobile electronic terminal on the basis of said comparison.

12. Device according to claim 11, wherein said controller is adapted for performing said comparison according to one or more parameters from the group comprising:
number of capabilities of said wireless interface;
type(s) of wireless interface capability/capabilities; and
position(s) of wireless interface capability/capabilities within said wireless interface capability data.

13. Device according to claim 11, wherein said controller is adapted for finding at least one correspondence between said received wireless interface capability data and said data sets, wherein said correspondence is an identical match or a similarity exceeding a pre-determined threshold, and for basing said determining of an identification of said mobile electronic terminal on
the single correspondence, in case a single correspondence is found;
or
a selected correspondence, in case multiple correspondences are found.

14. Device according to 13, wherein said controller is adapted for selecting said correspondence according to at least one of the group comprising:
number sold/in use of the mobile electronic terminal associated with said correspondence;
number/kind of features of the mobile electronic terminal associated with said correspondence; and
manufacturer of the mobile electronic terminal associated with said correspondence.

15. Device according to claim 11, wherein said wireless interface is a Bluetooth interface.

16. Device according to claim 11, further comprising a memory component adapted to be accessed by said database access component.

17. Device according to claim 16, wherein said memory component is adapted for storing said database comprising said plurality of data sets.

18. Device according to claim 16, wherein said memory component is adapted for storing associations between mobile electronic terminal identifiers and client software suitable for respective mobile electronic devices, and wherein said controller is further adapted for selecting a client software from said stored associations in accordance with said identification of said mobile electronic terminal, and for transmitting said selected client software to said mobile electronic terminal using said wireless interface.

19. Device according to claim 16, wherein said memory component is adapted for storing associations between mobile electronic terminal identifiers and data content suitable for respective mobile electronic devices, wherein said controller is further adapted for selecting content data in accordance with said identification of said mobile electronic terminal, and for transmitting said selected content data to said mobile electronic terminal using said wireless interface.

20. Device according to claim 16, wherein said memory component is adapted for storing associations between mobile electronic terminal identifiers and data services suitable for respective mobile electronic devices, wherein said controller is further adapted for selecting a service in accordance with said identification of said mobile electronic terminal, and for enabling said selected service for said mobile electronic terminal.

21. Device according to claim 16, wherein said received wireless interface capability data include a unique wireless interface identifier, and wherein said controller is further adapted for storing an association between said unique wireless interface identifier and said mobile electronic terminal in said memory component.

22. System comprising at least one device according to claim 11, and further comprising:
a memory component storing said database comprising said plurality of data sets; and
an interface component adapted for providing said database access component access to said database.

23. System according to claim 22, wherein said memory component further stores associations between mobile electronic terminal identifiers and client software suitable for respective mobile electronic devices, and wherein said controller is further adapted for selecting a client software from said stored associations in accordance with said identification of said mobile electronic terminal, and for transmitting said selected client software to said mobile electronic terminal using said wireless interface.

24. System according to claim 22, wherein said memory component further stores associations between mobile electronic terminal identifiers and data content suitable for respective mobile electronic devices, wherein said controller is further adapted for selecting content data in accordance with said identification of said mobile electronic terminal, and for transmitting said selected content data to said mobile electronic terminal using said wireless interface.

25. System according to claim 22, wherein said memory component further stores associations between mobile electronic terminal identifiers and data services suitable for respective mobile electronic devices, wherein said controller is further adapted for selecting a service in accordance with said identification of said mobile electronic terminal, and for enabling said selected service for said mobile electronic terminal.

26. System according to claim 22, wherein said received wireless interface capability data include a unique wireless interface identifier, and wherein said controller is further adapted for storing an association between said unique wireless interface identifier and said mobile electronic terminal in said memory component.
